(19) United States
(12) Patent Application Publication
(10) Pub. No.: US 2007/0039789 A1
(43) Pub. Date: Feb. 22, 2007

(54) Disk brake pad

(76) Inventor: Tatsuya Sano, Nisshin-shi (JP)

Correspondence Address: BUCHANAN, INGERSOLL & ROONEY PC, POST OFFICE BOX 1404, ALEXANDRIA, VA, 22313-1404, US

(21) Appl. No.: 11/506,836

(22) Filed: Aug. 21, 2006

(30) Foreign Application Priority Data
Aug. 22, 2005 (JP) 2005-239842
May 15, 2006 (JP) 2006-135079
Aug. 11, 2006 (JP) 2006-219659

(51) Int. Cl. F16D 65/04

(52) U.S. Cl. 188/250 B

(57) ABSTRACT

A disk brake pad has a friction member that slidably contacts to a rotating disk to generate braking force, and a backing plate that supports a back of the friction member. The friction member has a contact surface that slidably contacts to the disk. The backing plate has a heat transfer member located within a projected area, which reduces or restrains thermal deformation of a disk.

This application claims priority to Japanese patent applications serial number 2005-239842, 2006-135079 and 2006-219659, the contents of which are incorporated herein by reference.

### BACKGROUND OF THE INVENTION

1. Field of the Invention

The present invention relates to a disk brake pad having a friction member that slidably contacts to a rotating disk to generate braking force, and a backing plate of supporting a back of the friction member.

2. Description of the Related Art

Prior brake pads have included a backing plate and the friction member as components of the pad are fixed to each other via an insulator which has been set to have heat conductivity of 1.6 W/mK. The insulator has a copper fiber as a compounding component as one of means for increasing heat conductivity. Accordingly, the insulator increases heat conductivity of a pad as a whole, and radiation performance of the pad improves. As a result, a brake noise can be reduced during braking.

However, the friction heat generated during braking tends to have high temperature in an outer circumferential side portion compared with an inner circumferential side portion in a radial direction of the disk. This is because an outer circumferential side of the disk is moving in a high speed compared with the inner circumferential side, and consequently heat generation in the outer circumferential side is larger than that in the inner circumferential side. Therefore, during braking, the disk may have temperature difference in a radial direction, causing thermal deformation (thermal falling) in a rotation axis direction. The temperature difference in the radial direction of the disk is not eliminated even if the pad as a whole is increased in heat conductivity as in the related art.

### SUMMARY OF THE INVENTION

It is accordingly an object of the present invention to reduce the temperature difference between the inner circumferential side portion and the outer circumferential side portion of the disk associated with friction heat during braking, so that temperature in the radial direction of the disk is made uniform to prevent thermal deformation.

In one aspect of the present invention, a friction member has a contact surface that slidably contacts to a disk. A backing plate has heat transfer members in a projected area. In this configuration, the heat transfer members are holes. A ratio of an area occupied by the holes in the projected area is set such that it is small in an outer circumferential side portion of a radially outer side of a circumferential line compared with an inner circumferential side portion of a radially inner side of the circumferential line, the line having a rotational center of the disk as a center and passing through a center of an adhering surface of the friction member to the backing plate.

Further, the backing plate is typically made of iron, and has high heat conductivity compared with the friction member. Therefore, since the pad has a different hole ratio between the inner circumferential side portion and the outer circumferential side portion, heat radiation is higher in the outer circumferential side portion having a small hole ratio.

Therefore, the outer circumferential side portion of the disk, in which temperature tends to increase due to friction heat during braking, easily radiates heat by the outer circumferential side portion of the pad, consequently the temperature difference in a radial direction of the disk is reduced by the pad. As a result, the pad will reduce or restrain thermal deformation of the disk during braking.

In another aspect of the present invention, an area ratio occupied by the holes in the inner circumferential side portion is set to be at least 35%, and it in the outer circumferential side portion is set to be 20% or less.

In another aspect of the present invention, a friction member has a contact surface that slidably contacts to a disk. The backing plate includes a heat transfer member, which in this configuration, is structured such that a volume ratio of a backing plate to the friction member is set to be large in the outer circumferential side portion in the radially outer side of the circumferential line compared with the inner circumferential side portion in the radially inner side of the circumferential line, the line having the rotational center of the disk as the center and passing through the center of the adhering surface of the friction member to the backing plate.

Therefore, since the volume ratio of a backing plate to the friction member in the outer circumferential side portion is larger than the ratio in the inner circumferential side portion, heat radiation in the outer circumferential side portion is higher than the heat radiation in the inner circumferential side portion. Whereby, the outer circumferential side portion of the disk, in which temperature tends to be increased due to friction heat during braking, easily radiates heat by the outer circumferential side portion of the pad, consequently the temperature difference in a radial direction of the disk is reduced by the pad. As a result, the pad will reduce or restrain thermal deformation of the disk during braking.

In another aspect of the present invention, the volume ratio in the outer circumferential side portion is set to be at least 1.5 times larger than that in the inner circumferential side portion.

In another aspect of the present invention, a friction member has a contact surface that slidably contacts to a disk. Heat flow from the contact surface to a back of the backing plate is set to be large in the outer circumferential side portion in the radially outer side of a circumferential line compared with the inner circumferential side portion in the radially inner side of the circumferential line, the circumferential line having the rotational center of the disk as the center and passing through the center of the adhering surface of the friction member to the backing plate.

Therefore, since the heat flow from the contact surface to the back of the backing plate in the outer circumferential side portion is larger than the heat flow in the inner circumferential side portion, heat radiation in the outer circumferential side portion is higher than the heat radiation in the inner circumferential side portion. Whereby, the outer circumferential side portion of the disk, in which temperature tends to be increased due to friction heat during braking, easily radiates heat by the outer circumferential side portion of the pad, consequently temperature difference in a radial direction of the disk is reduced by the pad. As a result, the pad will reduce or restrain thermal deformation of the disk during braking.

In another aspect of the present invention, between a backing plate and a friction member is a heat transfer member structured as an adhesion layer for bonding them to each other. The adhesion layer has an adhesion layer of low heat conductivity in the inner circumferential side portion of the projected area of the contact surface. The layer includes a material having lower heat conductivity than that of the friction member, and has an adhesion layer of high heat conductivity in the outer circumferential side portion of the projected area of the contact surface. Further, the layer includes a material having higher heat conductivity than that of the friction member.

Therefore, heat conductivity of a material used for an adhesive layer is changed, thereby only a heat flow from the contact surface to the back of the backing plate in the inner and outer circumferential side portions of the pad can be significantly changed without significantly changing properties of the pad that slidably contacts to the disk, that is, properties directly concerning brake performance such as a friction coefficient and an elastic modulus.

### BRIEF DESCRIPTION OF THE DRAWINGS

FIG. 1 is a plane view of a disk brake for a vehicle;

FIG. 2 is a cross-sectional view taken along line II-II in FIG. 1;

FIG. 3 is a cross-sectional view taken along line III-III in FIG. 1;

FIG. 4 is a plane view of a pad;

FIG. 5 is a plane view of a pad of another configuration of the present invention;

FIG. 6 is a cross-sectional view taken along line VI-VI in FIG. 5;

FIG. 7 is a plane view of a pad of another configuration of the present invention; and

FIG. 8 is a plane view of a pad of another configuration of the present invention.

### DETAILED DESCRIPTION OF THE INVENTION

Each of the additional features and teachings disclosed above and below may be utilized separately or in conjunction with other features and teachings to provide improved disk brake pads. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful configurations of the present teachings.

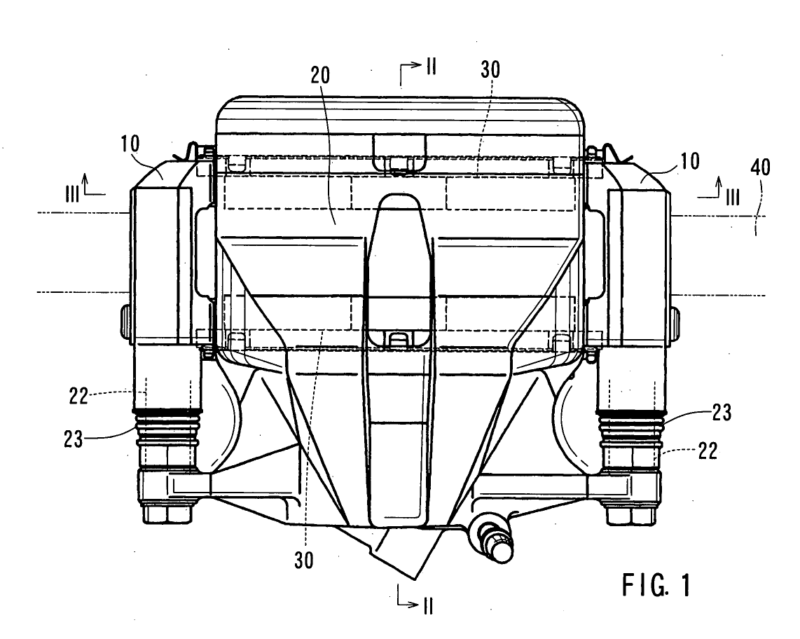

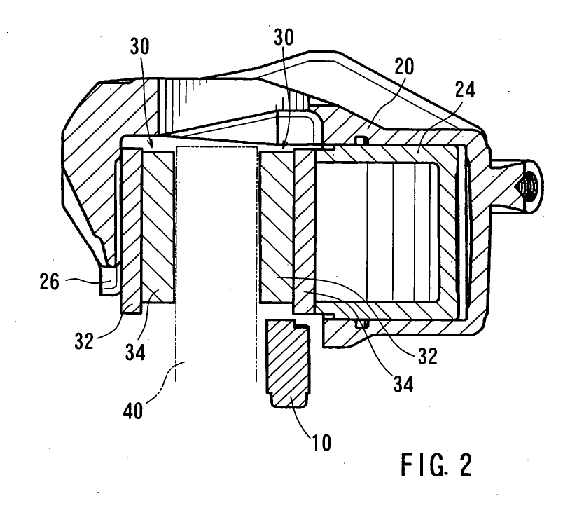

As shown in FIGS. 1 to 4, the configuration is designed for a floating disk brake. This type of disk brake has a mount 10, caliper 20, and a pair of pads 30. The mount 10 is attached to a member (omitted to be shown) at a vehicle side, and supports each of the pads 30 at inner side and outer sides of a disk 40 respectively (FIGS. 1 and 2).

The caliper 20 is attached to a mount 10 through two slide pins 22 parallel to a rotational axis of the disk 40. The slide pins 22 are slidably supported to the mount 10, and fixed to the caliper 20. Therefore, the caliper 20 is supported to the mount 10 by the slide pins 22 in a manner that it can reciprocate in a direction along the rotational axis of the disk 40 (left and right direction in FIG. 2). Dust boots 23 cover outer circumferences of the slide pins 22 between the mount 10 and the caliper 20.

The caliper 20 has a piston 24 at the inner side (right in FIG. 2) of the disk 40, and has one or more claws 26 at the outer side (left in FIG. 2). During braking, the piston 24 presses the pad 30 at the inner side to inner side face of the disk 40. Along with this, the caliper 20 is moved to a direction opposite to the direction of the piston 24, and the claws 26 press the pad 30 at the outer side to an outer side face of the disk 40.

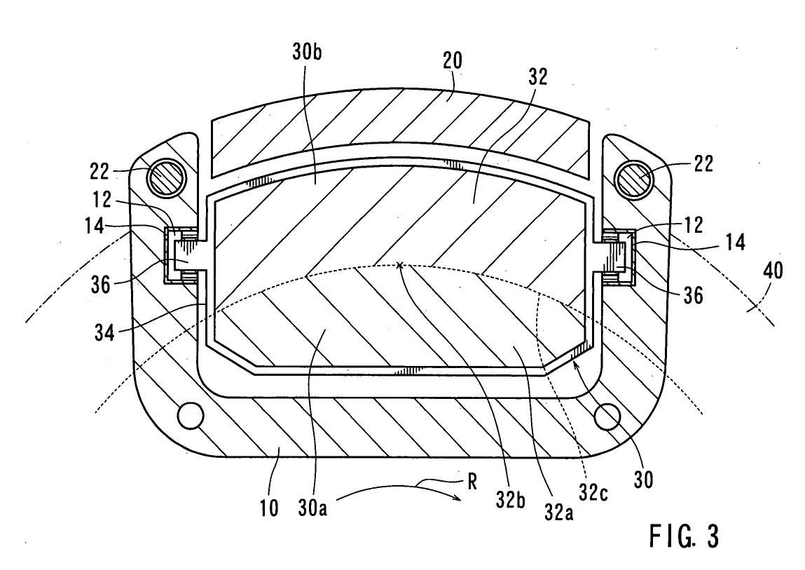

Both pads 30 include friction members 32 and backing plates 34 as shown in FIGS. 2 and 3. The friction member 32 has a contact surface 32a that is pressed to the disk 40 during braking, and brakes a rotating disk 40 by a friction force generated between the contact surface 32a and the disk 40. The perimeter of contact surface 32a defines a projected area of pad 30.

The backing plate 34 is made of metal or resin, and formed of a material having high heat conductivity compared with the friction member 32. The backing plate 34 is fixed to a back of the friction member 32 by an adhesive or the like, thereby supports the back of the friction member 32. The backing plate 34 has guide portions 36 at both ends in a rotational direction of the disk 40, that is, in a disk rotation outlet side (right side in FIG. 3) and a disk inlet side (left side in FIG. 3). The guide portions 36 are in a convex shape of projecting in the rotational direction of the disk 40 respectively. The disk rotation outlet side and the disk rotation inlet side of the disk are defined using a state, wherein the disk 40 is rotated in an arrow R direction in FIG. 3 (normal rotation) during a forward movement of a vehicle, as a reference.

The mount 10 has supporting portions 12 at both sides in the rotational direction of the disk 40 as shown in FIG. 3. The supporting portions 12 are set to be in a concave shape such that they can receive and support the both guide portions 36 of the pad 30 (backing plate 34) respectively, and guide the guide portions 36 in a direction along the rotational axis of the disk 40 (thickness direction of the pad 30). Support members 14 formed of sheet spring members are interposed between both supporting portions 12 and both guide portions 36. The support members 14 support both guide portions 36 of the pad 30 in a floating state by elasticity of the members respectively, and exhibit a biasing force in a direction pushing the pad 30 away from the disk 40 when braking is released.

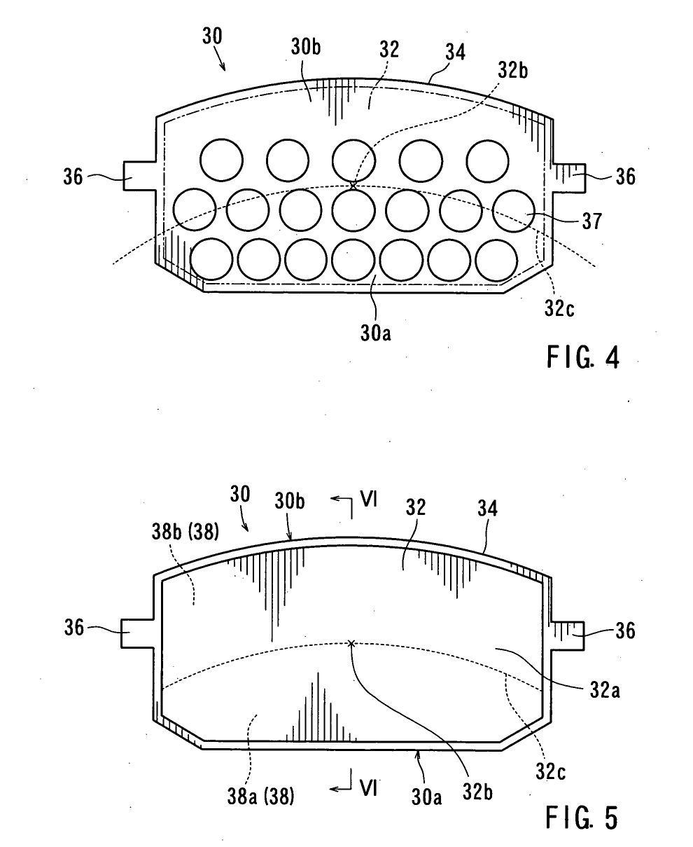

As shown in FIG. 4, the backing plate 34 of the pad 30 includes a heat transfer member. In this configuration, the heat transfer member is structured as holes 37. The holes 37 are located within in a projected area, the projected area defined by the perimeter of the contact surface 32a. A number of the holes formed in an inner circumferential side portion 30a are larger than that of the holes formed in an outer circumferential side portion 30b. The inner circumferential side portion 30a is the projected area in a radially inner side of a circumferential line 32c. The circumferential line 32c is a line which has a rotational center of the disk 40 as a center and passes through a center 32b of an adhering surface of the friction member 32 to the backing plate 34. The outer circumferential side portion 30b is the projected area in a radially outer side of the circumferential line 32c.

A diameter of each hole 37 is desirably set to be within a range of 10 to 25 mm. Each hole 37 may penetrate the backing plate 34, or may be a concave shape formed on a back or front face of the backing plate 34.

An area ratio occupied by the holes 37 in the projected area is set such that it is small in the outer circumferential side portion 30b compared with the inner circumferential side portion 30a. Specifically, the area ratio in the outer circumferential side portion 30b is set to be 20% or less and preferably 15% or less, and it in the inner circumferential side portion 30a set to be at least 35% and preferably at least 40%.

In the pad 30, a volume ratio of the backing plate 34 to the friction member 32 is different between the inner circumferential side portion 30a and the outer circumferential side portion 30b. That is, the volume ratio of the backing plate 34 to the friction member 32 in the projected area is set to be large in the outer circumferential side portion 30b compared with the inner circumferential side portion 30a. Specifically, the volume ratio in the outer circumferential side portion 30b is set to be at least 1.5 times larger than that in the inner circumferential side portion 30a, and preferably set to be at least 2 times larger.

Because of a configuration as above, in the pad 30, a heat flow from the contact surface 32a of the friction member 32 to the back of the backing plate 34 is different between the inner circumferential side portion 30a and the outer circumferential side portion 30b. That is, the heat flow from the contact surface 32a to the back of the backing plate 34 in the projected area is set to be large in the outer circumferential side portion 30b compared with the inner circumferential side portion 30a.

Accordingly, in the pad 30, heat radiation is high in the outer circumferential side portion 30b compared with the inner circumferential side portion 30a. Therefore, the outer circumferential side portion of the disk 40, in which temperature tends to increased due to friction heat during braking, easily radiates heat by the outer circumferential side portion 30b of the pad 30. Consequently, the temperature difference in a radial direction of the disk 40 is reduced by the pad 30. As a result, the pad 30 will reduce or restrain thermal deformation of the disk 40 during braking.

The heat flow Q is measured by a thin film of a heat flow meter, which is adhered to the whole area (or approximately whole area) of the back (approximately the same plane as a surface contacted to the piston or the claws of the caliper) of the backing plate 34, but which does not extend into holes 37. The heat flow Q is defined as Q=λ/d·ΔT, wherein λ is heat conductivity, d is thickness, and ΔT is temperature difference between a surface and a back of the thin film.

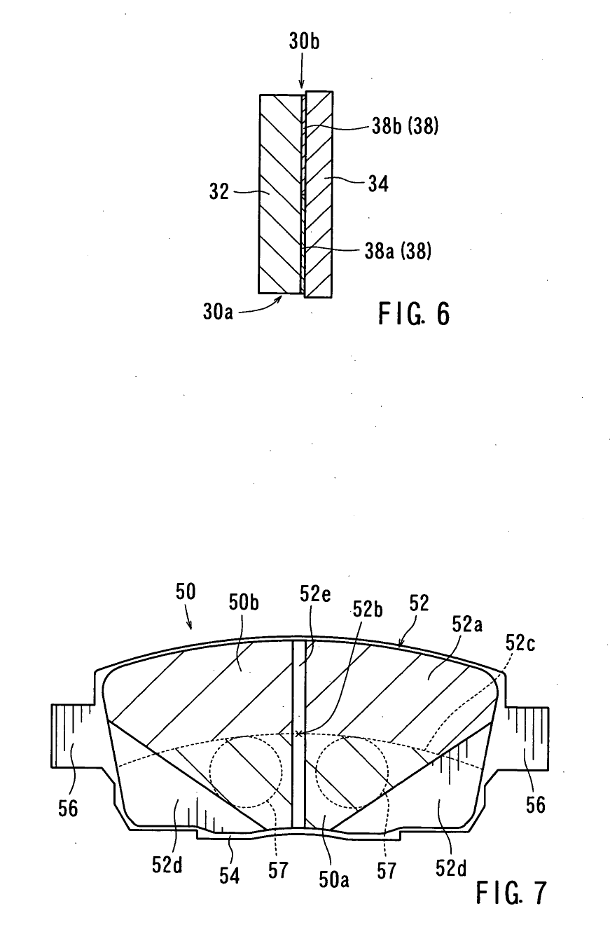

Another configuration will now be described with reference to FIGS. 5 and 6. The pad 30 in this configuration includes a friction member 32 connected to a backing plate 34 by an adhesion layer 38, wherein heat conductivity of the adhesion layer 38 is designed to be different between the inner circumferential side portion 30a and the outer circumferential side portion 30b of the pad 30.

That is, the adhesion layer 38 has at least two types of adhesion layers 38a and 38b, wherein the adhesion layer 38a is an adhesion layer of low heat conductivity including a material having lower heat conductivity than that of the friction member 32, and provided in the inner circumferential side portion 30a. On the other hand, the adhesion layer 38b is an adhesion layer of high heat conductivity including a material having higher heat conductivity than that of the friction member 32, and provided in the outer circumferential side portion 30b.

Accordingly, in the pad 30, the heat flow between the inner circumferential side portion 30a and the outer circumferential side portion 30b can be changed only by selecting a material of the adhesion layer 38 without engaging the backing plate 34.

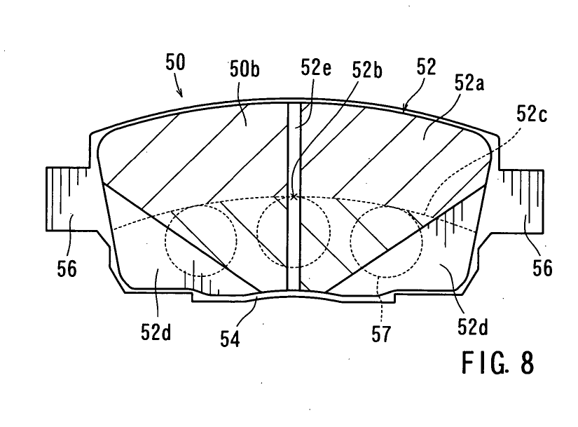

FIGS. 7 and 8 show additional configurations according to the present invention. A pad 50 includes a friction member 52 and a backing plate 54, and further includes heat transfer members.

The friction member 52 has a contact surface 52a that slidably contacts the disk, a pair of chamfered portions 52d chamfered obliquely in the thickness direction from both ends of the contact surface 52a, and a slit 52e extending in a disk diameter direction in the center at a surface side.

The backing plate 54 has guide portions 56 in both ends at a disk rotation inlet side and a disk rotation outlet side of the disk. In each of the configurations, the heat transfer member is structured as holes 57. The backing plate 54in FIG. 7 has two holes 57 formed therein, and the backing plate 54 in FIG. 8 has three holes 57 formed therein. The holes 57 are formed within or near an inner circumferential side portion 50a, and not formed in an outer circumferential side portion 50b. The inner circumferential side portion 50a is in a radially inner side of a circumferential line 52c. The circumferential line 52c has a rotational center of the disk as a center and passes through a center 52b of an adhering surface of the friction member 52 to the backing plate 54. The outer circumferential side portion 50b is in a radially outer side of the circumferential line 52c.

Each hole 57 may penetrate the backing plate 54, or may be in a concave shape formed on a back or front face of the backing plate 54. A ratio of an area occupied by the holes 57 to an area of the backing plate 54 is set large in the inner circumferential side portion 50a compared with the outer circumferential side portion 50b.

While the invention has been described with reference to specific configurations, it will be apparent to those skilled in the art that many alternatives, modifications and variations may be made. Accordingly, the present invention is intended to embrace all such alternatives, modifications and variations that may fall within the spirit and scope of the appended claims. For example, the present invention should not be limited to the representative configurations, but may be modified as described below.

In FIG. 4, the backing plate 34 is shown in a configuration where the number of holes 37 was gradually decreased from the inner circumferential side portion 30a to the outer circumferential side portion 30b. However, it can be configured in a way that size of the holes 37 is decreased from the inner circumferential side portion 30a to the outer circumferential side portion 30b.

In FIGS. 4, 7 and 8, the backing plates 34 and 54 includes holes 37 and 57. However, they can be configured in a way that a filler having a material different from materials of the backing plates 34 and 54 is filled into all or part of the holes 37 and 57. In this case, the material of the filler is selected such that heat conductivity of the filler is high in the outer circumferential side portions 30b and 50b compared with the inner circumferential side portions 30a and 50a, thereby temperature difference between the inner circumferential side portions 30a, 50a and the outer circumferential side portions 30b, 50b of the pads 30, 50 can be further effectively reduced. Heat conductivity of typical materials used for the pad is given as follows: 40 to 50 W/mK in the backing plate (iron), 0.5 to 2.0 W/mK in a non-asbestos organic material used for the friction member, and 2.5 to 5.0 W/mK in a steel material.

We claim:

1. A disk brake pad comprising:
a friction member including contact surface;
a backing plate that supports a back of the friction member;
wherein the backing plate includes holes in a projected, and
a ratio of an area occupied by the holes in the projected area is small in an outer circumferential side portion in a radially outer side of a circumferential line compared with an inner circumferential side portion in a radially inner side of the circumferential line.

2. The disk brake pad as in claim 1, wherein the area ratio occupied by the holes in the inner circumferential side portion is set to be at least 35%, and it in the outer circumferential side portion is set to be 20% or less.

3. A disk brake pad comprising:
a friction member including a contact surface;
a backing plate that supports a back of the friction member;
a volume ratio of the backing plate to the friction member in a projected area is large in an outer circumferential side portion in a radially outer side of a circumferential line compared with an inner circumferential side portion in a radially inner side of the circumferential line.

4. The disk brake pad as in claim 3, wherein the volume ratio in the outer circumferential side portion is set to be at least 1.5 times larger than that in the inner circumferential side portion.

5. A disk brake pad comprising:
a friction member including a contact surface;
a backing plate that supports a back of the friction member;
a heat flow from the contact surface to a back of the backing plate in a projected area is large in an outer circumferential side portion in a radially outer side of a circumferential line compared with an inner circumferential side portion in a radially inner side of the circumferential line.

6. The disk brake pad as in claim 5, further comprising:
an adhesion layer between the backing plate and the friction member for bonding them to each other;
wherein the adhesion layer has an adhesion layer of low heat conductivity in the inner circumferential side portion of the projected area of the contact surface, the layer including a material having lower heat conductivity than that of the friction member, and has an adhesion layer of high heat conductivity in the outer circumferential side portion of the projected area of the contact surface, the layer including a material having higher heat conductivity than that of the friction member.

7. A disk brake system comprising:
a disk;
a pad including a friction member and a backing plate to support the friction member, wherein the pad is positioned proximate the disk; and
a heat transfer member structured and positioned on the pad to reduce thermal deformation of the disk.

8. The disk brake system as in claim 7, wherein the heat transfer member is a plurality of holes positioned on the backing plate.

9. The disk brake system as in claim 8, wherein the backing plate further includes an inner and outer circumferential side portion.

10. The disk brake system as in claim 9, wherein a majority of the plurality of holes are positioned within the inner circumferential side portion.

11. The disk brake system as in claim 9, wherein a ratio of an area occupied by the plurality of holes within the outer circumferential side portion is small as compared with an inner circumferential side portion.

12. The disk brake system as in claim 7, heat transfer member is a plurality of concave shaped portions positioned on a back of the backing plate.

13. The disk brake system as in claim 7, wherein the heat transfer member is a volume ratio of the backing plate to the friction member, wherein the volume ratio is set to be large in an outer circumferential side portion of the backing plate compared with an inner circumferential side portion of the backing plate.

14. The disk brake system as in claim 7, wherein the heat transfer member includes portions defining a plurality of holes, wherein the plurality of holes are positioned substantially within an inner circumferential side portion of the backing plate.

15. The disk brake system as in claim 14, wherein the plurality of holes includes 3 holes.

16. The disk brake system as in claim 14, wherein the plurality of holes includes 2 holes.

17. The disk brake system as in claim 7, wherein the heat transfer member is an adhesive layer positioned between the friction member and the backing plate.

18. The disk brake system as in claim 17, wherein the adhesive layer includes a first portion and a second portion.

19. The disk brake system as in claim 18, wherein the first portion includes material of low heat conductivity and a second portion includes material of high heat conductivity.

20. The disk brake system as in claim 19, wherein the first portion is positioned proximate to an inner circumferential side portion of the backing plate, the first portion having lower heat conductivity than that of the friction member, and wherein the second portion is positioned proximate an outer circumferential side portion of the backing plate, the second portion having high heat conductivity than that of the friction member.
